(19) United States
(12) Patent Application Publication
(10) Pub. No.: US 2005/0278189 A1
(43) Pub. Date: Dec. 15, 2005

(54) Process & methods for content adaptive learning

(75) Inventors: Michael J. Mercadante, Milpitas, CA (US); Vijay Aswadhati, San Jose, CA (US)

Correspondence Address: MICHAEL MERCADANTE, 1900 STRATFORD DRIVE, MILPITAS, CA, 95035, US

(73) Assignee: ISense Technology, Inc.

(21) Appl. No.: 11/138,992

(22) Filed: May 26, 2005

Related U.S. Application Data
(60) Provisional application No. 60/574,545, filed on May 27, 2004.

(51) Int. Cl. G06F 17/60

(52) U.S. Cl. 705/1

(57) ABSTRACT

A Business system for Content Adaptive Learning for assisting teams with continuous improvement of customer service by a 360 degree view (Agent, Customer, & Manager) of their performance against goals and performance measures, enabled by a set of processes and methods which create a Learning Center, a set of processes and methods which enable Real-Time Content Detection, a set of processes and methods which create a set of Proactive Behaviors, a set of processes and methods enabling Learning and a set of processes and methods enabling Behavior Change.

### CROSS-REFERENCE

This application claims the benefit of U.S. Provisional Application No. 60/574,545, filed May 27, 2004, which is incorporated herein by reference in its entirety.

### STATEMENT AS TO FEDERALLY SPONSORED RESEARCH

This invention was made with the support of the United States government under Contract number by NAME OF AGENCY.

### BACKGROUND OF THE INVENTION

### SUMMARY OF THE INVENTION

Objects:

Process & Methods for Content Adaptive Learning

1.0 General Objects

1.a The invention will integrate methods and processes of observation and detection, proactive behaviors, learning, with behavior change into a Adaptive Learning for improving individual and team behaviors and performance.

1.b The invention will recursively apply methods and processes of data navigation to visually illustrate the level of synergy or dissidence between the observed views of all individuals involved in an interaction to guide self improvement and team learning.

2.0 Objects of Content Detection

2.a The invention will detect keywords & phrases in video, voice, and textual media streams in real-time based on expressed events of interest.

2.b The invention will detect emotional content in video, voice, and textual based interactions in real-time.

2.c The invention will detect attributes of interactions from this and other systems as a means of expanding the precision and breadth of business rules which can be created and acted upon.

2.d The invention will detect content in a manner which is time synchronized enabling accurate correlation of events and definition of causal relationships.

2.e The invention will apply a ‘consistent’ method of ranking confidence level of observed events of interest.

3.0 Objects of Pro-Active Behaviors Based on Business Norms

3.a The invention will provide methods and processes which enable it to contrast observed events of interest to business norms and industry standards and initial subsequent processing.

3.b The invention will provide a method of describing business norms to guide alerting and reasoning behavior.

3.c The invention will provide a visual and message based status and alerts, in realtime, to enable human intervention in interactions which are not meeting desired business norms.

4.0 Objects of Learning

4.a The invention will use temporal correlation of events of interest as a means to improve confidence levels.

4.b The invention will use temporal correlation and detection confidence levels as a means to show causal relationships and patterns of behavior over time (i.e. multiple interactions).

4.c The invention will detect content in a manner which is self correcting for improved accuracy over time & observed experiences.

4.d The invention will provide a method of ‘self learning’ based on past experiences and target norms.

4.e The invention will apply processes and methods of logic based reasoning to make recommendations.

4.f The invention will apply processes and methods of forward and backward reasoning to make recommendations.

5.0 Objects of Behavior Change 5.a The invention will use graphical techniques to present current performance levels for individuals and teams against business and industry norms. It will also graphically illustrate cause and effect relationships between events of interest of the participants.

5.b The invention will use gauges which incorporate business norms and average levels of performance to communicate actual status against business norms and guide behavior change.

5.c The invention will conditional communicate surveys to individuals involved in an interaction to collect their perspectives on the interaction consistent with the methods and processes of data navigation.

5.d The invention applies the methods & processes of data navigation to collected survey responses and integrates the visual presentation of business norms and recommendations based on individual and team experiences.

5.e The invention will apply graphical and textual representation of performance over time for specific business norms (metrics) vs. goals for individuals and teams.

Advantages:

An advantage of the invention is that it alerts supervisors and agents in real-time that interactions are occurring which exceed business norms enabling immediate action or escalation providing customers with a greater level of responsiveness and effectiveness of interactions.

An advantage of the invention is that it is highly configurable enabling an enterprise to set its own expectations of performance.

An advantage of the invention is that the system can dynamically alter its configuration based on past experiences enabling it to adapt to a changing enterprise.

An advantage of the invention is that it presents information in highly visual mechanisms which make the presentation of large volumes of information easy to view in a short period of time further enhancing the enterprises behavior to react to changes in interactions dynamically.

An advantage of the invention is that it applies the notion of triangulation to data navigation to enable members of the enterprise to see gaps or commonality of perspectives of performance helping guide corrective behaviors and learning within ‘minutes’ of the interaction events being detected.

An advantage of the invention is that it identifies in a real-time and proactive manner the places where supervisors and agents need to spend their time to improve customer satisfaction.

An advantage of the invention is that content is extracted from the media stream in real-time in the form of attributes, keywords, emotions, and gestures enabling accurate and timely assessment of the quality of an interaction with a customer.

An advantage on the invention is that the temporal correlation of content detectors results acts to improve the accuracy of the interaction as requiring supervisor intervention.

An advantage of the inventions is to graphically illustrate cause and affect relationships between events and participants in the interaction better providing insights for corrective behavior.

An advantage of the invention is that it identifies patterns of behavior in time enabling both spontaneous and longer term organizational learning.

An advantage of the invention is that it provided a means for supervisors to correlate key performance measures and customer satisfaction in a causal relationship graphically and textually.

### Incorporation by Reference

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a summary view of the major components of this Business system for providing the process and methods of Content Adaptive Learning for assisting teams with continuous improvement of customer service by a 360 degree view (Agent, Customer, & Manager) of their performance against goals and performance measures.

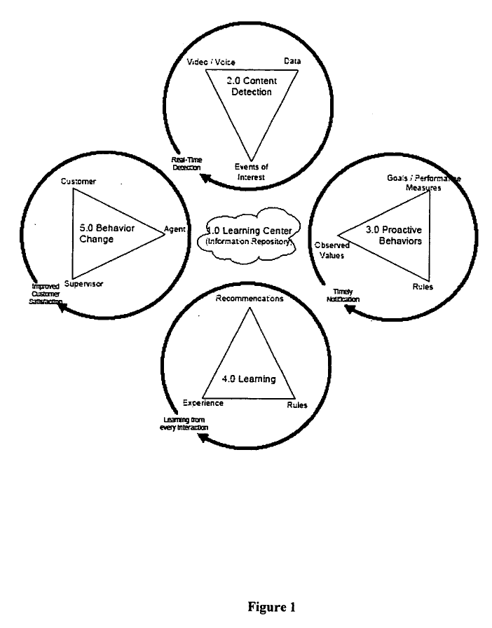

FIG. 2 illustrates a detailed view of the major components of this Business system for providing the process and methods of Content Adaptive Learning for assisting teams with continuous improvement of customer service by a 360 degree view (Agent, Customer, & Manager) of their performance against goals and performance measures.

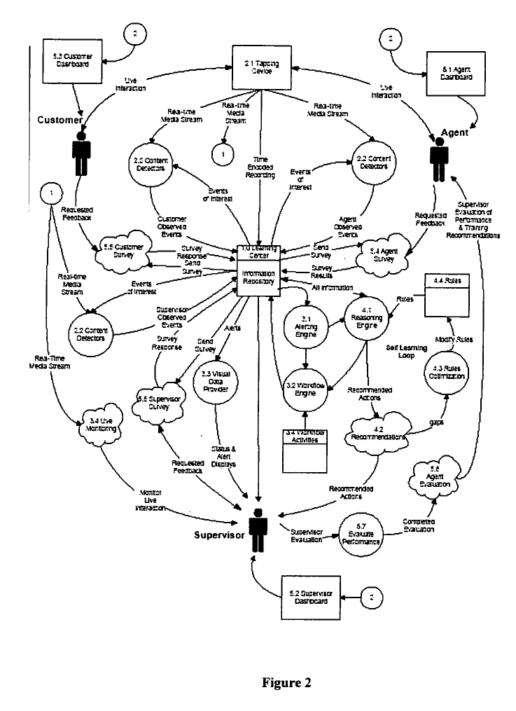

FIG. 3 illustrates a summary view of a system's implementation of this Business system for providing the process and methods of Content Adaptive Learning for assisting teams with continuous improvement of customer service by a 360 degree view (Agent, Customer, & Manager) of their performance against goals and performance measures.

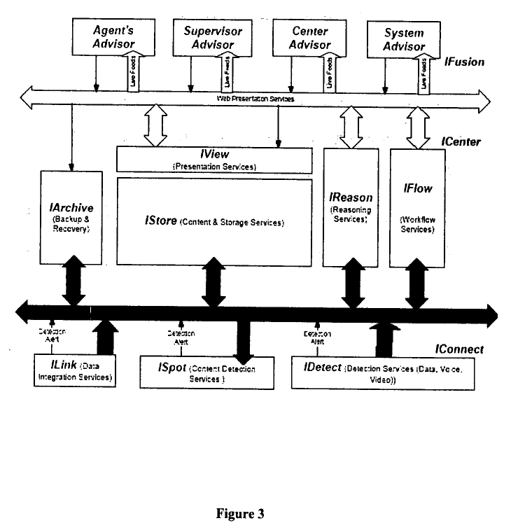

FIG. 4 illustrates an example visualizing information within this Business system for providing the process and methods of Content Adaptive Learning for assisting teams with continuous improvement of customer service by a 360 degree view (Agent, Customer, & Manager) of their performance against goals and performance measures.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.0 Learning Center—the Learning Center is a web based integration of content & data management mechanisms which enables the storage of events, documents, rules, metrics, and media with objective. The Learning Center is central it all of the key components which are described in this patent and its implementation.

2.0 Content Detection—the key components of component detection are the 2.1 Tapping Devices which provide real-time video, audio and data streams to the 2.2 Content Detectors. The Content Detectors update the 1.0 Learning Center with Events of Interest, events determined to be significant to operation of the enterprise. Content Detection occurs on both the media stream of the customer and the enterprises agent in order to provide events of interest from both perspectives. All of the activities are temporally synced with time code information so that synchronization of events and the media content can be done spontaneously or in post processing. Another benefit of this temporal synchronization is to enhance the confidence level of detectors. By having near coexistence of detected events of interest from multiple detectors the confidence level of a significant event within an interaction is significantly increased. The real-time media stream can also be provided to 3.4 Live Monitoring, which enables supervisory personal to monitor interactions which have been flagged to contain events of interest in live mode.

Proactive Behaviors—The invention provides for near real-time proactive behaviors as a result of detected values in the 1.0 Learning Center by the 3.1 Alerting Engine, in the system which are manifest in many possible forms. The 3.2 Workflow engine can present these alerts in many forms they can be as simple as a basic text message, and RSS data feed, an IM message, data contained in a scrolling banner on user screens. The scope of the actions is bounded only by the content of the 3.4 Workflow Actions data store. Workflow actions can be any set of system behaviors which can be constructed in the chosen scripting language of the implementation. Alerts can also trigger subsequent processing such as the activation of the 4.1 Reasoning Engine. Additionally alerts can be in the form of indicator lights, gauges and charts which are presented within the user interface of the implementation by 3.3 Visual Data Provider.

4.0 Learning—Learning behaviors are realized by the 4.1 Reasoning Engines output 4.2 Recommendations which are provided to the supervisor and in some cases to the Agent based on parameters set by the implementations operators. 4.3 Rules optimization process looks at the gaps between the recommendations and the rules and adapts over time the 4.4 Rules store using both forward and backward reasoning techniques. This cycle creates a self learning loop which enables the implementation to adapt to observed experiences over time.

5.0 Behavior Change—to affect behavior changes in the agent's interactions with customers in the future a collection of information in many forms is summarized and presented in a timely manner. The 5.1 Agent Dashboard is a configurable Dashboard of gauges, indicators, charts, attributes and textual data designed to present a current view of an agents with respect to business norms, individual and team performance. This is a central to the notion of data navigation, in order to affect change in behavior you must be able to present a navigational aid which helps the agent see in a timely manner what should change. To assist in the process, the supervisor is provided a broader view of operations via the 5.2 Supervisor Dashboard. This similar collection of information and mechanisms enables a supervisor to quickly see the status of events of interest during the interaction and to determine how their time is best spent in monitoring or participating in live interactions to mentor the agent and improve customer satisfaction. 5.3 Customer Dashboard provides ‘controlled’ information to the customer who can assist the participants in the overall process of improvement by enabling them to highlight key performance areas, as well as provide direct feedback in the form of a survey. When significant events occur which exceed desired business norms intervening action can be taken, One such action would be the initiation of a survey process. Central to our notion of data navigation and the Content Adaptive Evaluation Process, is the 360 degree Survey process. 5.4 Agent Survey, 5.5 Customer Survey, and 5.6 Supervisor Survey are triggered by business norms being exceeded. Key is the well formed questions set of the surveys which ask the same question from the three perspectives of the Agent, Customer, and Supervisor. Using the same measurement system the results from these surveys are correlated in the graphical form showing any viewer the gaps or synergy in the responses from these three perspectives on a particular interaction. The survey event is an automatically generated warning flag for the supervisor indicating that business norms during this interaction have been exceeded. Thus providing a clear set of interactions to review in ranked priority, significance, and confidence which enables substantial savings of time with greater repeatability. This trigger 5.7 Evaluate Performance which the supervisor/mentor needs to perform with in a predetermined period of time. The inclusion of the survey data, actual information from the events of interest are synchronized with the media stream showing a causal relationship between keyword events, emotions and key attributes of the interaction. Presenting a visual timeline of events of significance and recommendations. 4.2 Recommendations comes from the 4.1 Reasoning engines processing, which is augmented by the supervisors own experience based and expectation. All of this information is summarized in 5.8 Agent Evaluation which shows the events, interaction, the consequences and the recommendations all in a format which is highly graphical and can play back the interactions in a synchronized manner with the events and recommendations.

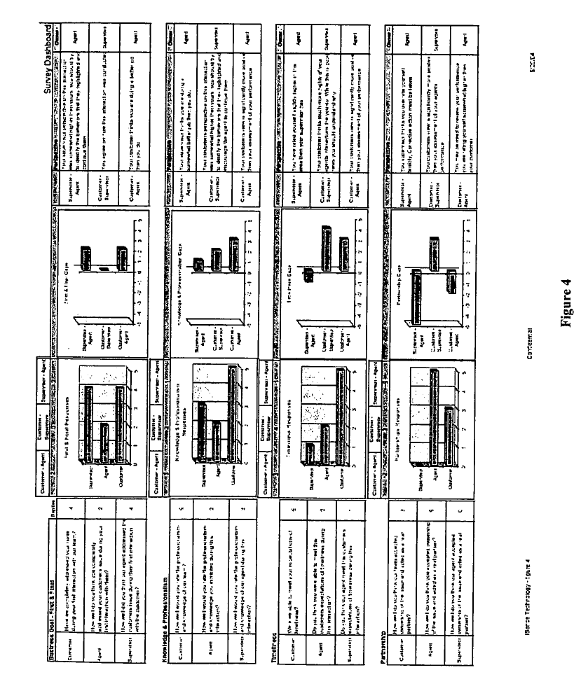

The consequence of these connections and interactions enables Agents to understand how to improve their performance from every interaction. See FIGS. 4 & 5 as an example.

Operation:

Operation of Invention

Effective operation of the invention is comprised of a cycle three main activities configuration, Operation and learning. If an enterprise is effectively using the invention this cycle will repeated routinely insuring that the goals, key performance indicators, and business norms are evolving with the organization. Thus the invention is an embodiment of a full system which enables an enterprise to ‘live’ a continuous learning cycle.

1. Configuration

1.1 Setup

Installation and setup of the invention involves linkage of physical and the logical data which describes the communications channel and the users of that channel.

System parameters required to operate the system such as the location of system resources, directories, licensing, capabilities of installed software and hardware, and other parameters which describe how the system should operate in a particular system configuration (Single or multi-node systems).

Communications Channels include but are not limited to traditional PSTN Analog Trunk and Station lines, Digital Trunk & Station lines, VOIP communications, e-mail, instant messenger sessions, and web interactions. So the definition of these physical devices, their location and their logical mappings.

Description of system users, their relationships to each other and departments, customization data for a personalized environment, as well as the security and access control data on a user basis.

Description of the Dashboards which present ‘live’ information to system users.

Description of work-flow processes and methods.

Installation & Configuration of selected detector types to meet the objectives of the enterprise.

1.2 Define goals, key performance indicators and norms linked to Business Strategy Key to the operation of the Content Adaptive Learning, the enterprise must describe its business goals and then transform these goals into a set of Key Performance Indicators and expected norms. These KPI's should be categorized into sets such as effectiveness, efficiency, and customer satisfaction and align them to their Business Strategy.

Link Key performance indicators to Business Goals and Strategies.

Establish business norms for Key Performance indicators by individual, experience level, or team.

In organizations with more experience in using metrics and measuring performance combinations of individual experience, and team metrics may be constructed and applied.

Communicate the goals, key performance indicators and expected performance levels using the individual and team supporting options provided.

Balance your Key Performance indicators into categories such as efficiency, effectiveness and customer satisfaction. Using the reporting options to provide a pictorial view of your key performance indicators by category and their linkage to your business goals and strategies.

Select if particular business norms are goals or thresholds. (Goals are values to strive for, while thresholds are values never to exceed).

Describe and implement work-flow behaviors which are to be performed.

Select the work-flow behaviors to be taken if a goal isn't achieved or a threshold is exceeded.

1.3 Create survey questions.

A critical component of our Content Adaptive Learning is the construction of well formed surveys which are to be sent out when particular events of interest or key performance indicators exceed desired business norms. In our view less is more when it comes to surveys. A few well formed questions consistently and routinely will provide much more useful data for an enterprise to operate on then many surveys which are complex and not well designed. Here are the key elements for the construction of 360 surveys;

Define clearly the objective of the survey.

Construct 3-4 question topics which reinforce your key business goals & strategies (Professionalism, Knowledge, Right the first time, Satisfaction Level).

For each topic ask essentially the same question from the perspective of the parties involved (Customer, Customer Service Agent, Supervisor).

Make sure to construct the questions in a manner that they don't lead the recipient to a desired conclusion.

Keep the rating system simple, 1to 3 or 1 to 5 and define the meaning of a 1,2,&3 in simple and relevant terms.

Our measurement techniques is to consistently and routinely apply a set of questions which are aligned to the key business objectives and performance measures, ask them from three perspectives in a blind survey form. Then to contrast the results and identify positive and negative gaps between responses, we use the magnitude of the difference in response for the relevant pairs, Customer to Agent, Customer to Supervisor, Agent to Supervisor as a means to find ‘our position’. We then translate these deltas on the three vectors into a recommended set of actions; the set of the actions will be described in the implementation part of this operational discussion later in the document.

2. Operation

The operation of the invention is comprised of a set of activities which are highly interactive processes and methods which operate in an on going cycle during each working day within the enterprise;

Content Detection processes & methods.

Pro-active Behaviors processes & methods.

Behavior Change processes & methods.

Central to the effective operation of the Content Adaptive Review is the creation of both system and human processes and methods which are carefully orchestrated and routinely measured.

2.1 Content Detection Processes & Methods

Once configured Content Detection processes & methods are automated real-time detectors which monitor interactions looking for specific content and making observations about events of interest, confidence level, and date and time.

Content Detector Family (Voice-Keyword/Phrase Detector, Voice-Emotion Detector, Attribute Detector, Text-Keyword Detector, Text-Emotion Detector, Video-Gesture Detector).

Selected Content Detectors observe Communications channels in Real-time and produce events of interest based on the configured system data. As an example Voice Keyword Detectors would produce observe the date and time those keywords/phrases of interest were observed and place the observed events in the systems database.

Content Detectors would routinely be checking the systems database for changes in their configuration information such as frequency of execution, user focus, or changes to the list of keywords/phrases of interest and alter their behavior accordingly.

All operational changes or status information from the family of content detectors would be placed in the system data base and use system alerting mechanisms to communicate immediately to personnel responsible for system operation.

2.2 Proactive Behaviors Processes & Methods.

Pro-active Behaviors are automated processes and methods which look at observed events of interest and act on them based on the predefined rules data (Key Performance Indicators, goals, & business norms, logic about these events and work-flow processes and methods which have been defined) on a continuous basis.

2.2.1 Routine Measurement

Routine measurement of these KPI's and performance against these norms must be presented consistently and objectively to all members of the team to be creditable. This process of routine measurement and display is central to setting performance expectations. Correlation of KPI performance and customer satisfaction should be periodically performed to ensure that the KPI's selected are relevant to the desired business objectives for customer satisfaction.

Operationally we provide measurement data in the forms of tables, reports, charts, graphs, gauges and indicators lights which are routinely refreshed with live data. Within all of the application modules of our implementation we have constructed dashboards to show summary views which can lead a user quickly to more specific detailed information. We also provide within all of our user views critical status information in the form of data feeds, indicator lights, and gauges to keep every individual appraised of how they are doing.

2.2.2 Presentation

Central to the operation of a Content Adaptive Learning is the effective communications of current status and activities of all vested parties involved in improving operational performance of the enterprise. We provide measurement data in the forms of tables, reports, charts, graphs, gauges and indicators lights which are routinely refreshed with live data. Within all of the application modules of our implementation we have constructed dashboards to show summary views which can lead a user quickly to more specific detailed information. We also provide within all of our user views critical status information in the form of data feeds, indicator lights, and gauges to keep every individual appraised of how they are doing.

Individual Dashboards with status information regarding their performance with respect to goals and business norms.

Alert messages which start at the individual involved in the interaction and are directed up the chain of command based on the frequency and severity of detection within an interaction.

2.2.3 Alerting Special mechanisms exist to provide immediate data to invoke immediate intervening human interaction in a live interaction based on the detection of a/set of significant events of interest. Among the mechanisms which are employed are;

Alert messages directed up the chain of command of team members involved in the interaction.

Live indicator lights on the displays of those same individuals.

Live Data feeds which can be presented to parties of interest.

2.3 Behavior Change Processes & Methods

The operation of the Behavior Changes Processes and Methods is a system assist set of human processes. Ultimately we are trying to show the gaps in perspectives from the involved parties, to show a causal relationship between the observed events of interest and the behaviors in the interaction, and to suggest changes in behavior, changes in process, or other actionable recommendations which will improve the performance of the individuals involved in the interaction and subsequently improve the performance of the organization. Three main activities are involved;

A Blind survey process which is executed by the Pro-active Behaviors Processes & Methods to capture three perspectives on any interaction which contained significant events of interest based on the express business goals & norms of the enterprise.

The survey can be delivered in a number of forms to the parties involved, via company computing infrastructure in the form of an email message with a URL to the survey form, a fax survey, or a paper survey which requires data entry on completion.

Upon completion of the three surveys or reaching some predefined expiration date a message is sent the supervisor of the individuals involved in the interaction that survey data has been completed and is ready for their review and evaluation.

2.3.1 Blind Survey

Performance outside of the norms established for the KPI's should trigger a ‘blind’ survey process. Where the questions of the survey are crafted in a manner to contrast from three perspectives how the customer interaction achieved its purpose and how well it was performed.

Consistently & Routinely.

2.3.2 Evaluation & Feedback

The Content Adaptive Learning is based on contrasting the separate perspectives of how the interaction proceeded, with factual observed events of interest, showing a causal relationship to the parties involved allowing them to get immediate feedback and recommendations for improvement.

Upon receipt of notice of a pending evaluation a supervisor/manager reviews the materials received (Survey Dashboard example see FIG. 4).

Reviews the recorded interaction media/data and the observed events of interest.

Reviews the system recommendations, and alters them and adds commentary and recommended actions/training materials.

2.3.3 Training

Training recommendations come in the form of system generated recommendations based on past experiences as well as supervisor/manager recommendations for training. Follow up on timely completion of recommended training materials, reading or video/audio examples are provided to ensure the closure of the Behavior change cycle.

3. Learning

By evaluating the history of Rules, Experiences, Measurements, and Recommendations the system will be able to make recommendations of how to improve it's configuration enabling enhanced operational performance.

Multiple learning loops exist within the process & methods set our in the invention. One is to make recommendations to users of the system on how to improve their performance. Another exists within the reasoning components of the processes & methods as a means to optimize the rules which are being used in the normal operation of the environment within a specific enterprise. Yet another is embodied by the processes and methods called out in the invention are a learning loop set up by the use of triangulation techniques and blind surveys. This is an integrated set of human and system processes and methods. Yet another learning loop is set up via the measurement data and changes in individual and team performance over time. This loop is continuously enhanced through the modification of individual and team goals and business norms as initial objectives are meet. This continuous loop sets up an ongoing comparison to past performance, targeted future performance, and contrasts that to industry norms.

1. A Business system for providing the process and methods of Content Adaptive Learning for assisting teams with continuous improvement of customer service by a 360 degree view (Agent, Customer, & Manager) of their performance against goals and performance measures, comprising; a set of methods and processes for creating a Learning Center which describes the body of knowledge required to represent interactions between customers and agents independent of the media used to record these interactions, the recorded media of the interaction, the rules which describe the desired behaviors of the team, the actions which are to be taken , as well as the representation of events which create a historical view of the team and individuals performance to specified goals and metrics; a set of methods and processes for real-time Content Detection (keywords, phrases, emotions) in live media streams (text, email, Interactive Chat, Telephony, Internet Telephony, Video Interactions) enabling the capture of interaction statistics, and real-time observation and proactive intervention; a set of methods and process describing the Proactive Behaviors (alerting, interaction tagging, triggered workflow, monitoring, escalation, intervention) which are to be taken during the discover of Events of Interest during the process of Content Detection; a set of methods and processes for individual's and team Learning which evaluate current and past performance which can make recommendations, trigger workflow, alter rules , alter performance metrics and goals, request intervention for the resolution of conflicting rules, objectives, metrics and or goals ; a set of process and methods for Individual and team Behavior change which provide for the routine presentation and visualization of actual performance vs. desired performance, with links to recommendations, rules, data, and workflow which support the recommendations, and visualization processes and methods which measure the changes in individual's and team's performance;
